(19) United States
(12) Patent Application Publication
(10) Pub. No.: US 2006/0254511 A1
(43) Pub. Date: Nov. 16, 2006

(54) ADHESIVE NOZZLE WITH COOLED MONITORING OPTICS

(75) Inventor: Wolfgang Puffe, Siegburg (DE)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 11/383,006

(22) Filed: May 12, 2006

(30) Foreign Application Priority Data
May 13, 2005 (DE) 102005023046.6-51

(51) Int. Cl. B05C 11/00; B05C 5/00

(52) U.S. Cl. 118/713; 118/712; 118/300

(57) ABSTRACT

A nozzle assembly for hot melt adhesive. The assembly includes a nozzle which is provided with a measuring head having cameras for monitoring hot melt adhesive discharged by the nozzle. A cooling device is arranged at the measuring head.

### FIELD

The invention relates to nozzle assemblies for dispensing hot melt adhesive, and particularly those assemblies having a monitoring device for monitoring adhesive output onto a substrate.

### BACKGROUND

Hot melt adhesives are used in many areas where, formerly, it was common practice to use different types of connecting or fastening technologies, such as bolts, tacks, sewing etc. For certain applications it is necessary to produce edge or line connections for which it is necessary to apply a single adhesive bead which, either in its entirety or in predetermined portions, does not have any interruptions.

Nozzle assemblies which produce such adhesive beads can be attached to a robot arm and controlled along two-dimensional curves or three-dimensional movements in space in a fully automated manner. For monitoring the quality of the adhesive beads produced in this way it is known to provide the nozzles with measuring heads which, more particularly, comprise three circumferentially distributed cameras which, at any time during the emergence of the adhesive, record an image of the adhesive bead as produced at three different viewing angles. The image can be monitored fully automatically via suitable image comparing programs, with an error message being generated if the adhesive bead deviates with respect to height, width or extension from predetermined image values contained in a memory.

The application of hot melt adhesive can often take place at increased temperatures of 180° C. or more. The adhesive is heated in a tank arranged at a distance from the individual nozzle, supplied by a pump via preferably heated pipes or hoses to a region close to the nozzle. Before reaching the nozzle, the adhesive is directed through a controlled gear pump. Accurate timing then takes place at the nozzle aperture via a pneumatically or electrically controlled nozzle needle. The nozzle, gear pump and, if applicable, a manifold connecting the two, are typically heated to the temperature of the adhesive. Experience has shown that the temperatures occurring in the nozzle environment adversely affect the functioning of the measuring head, more particularly, the temperature-sensitive cameras.

### SUMMARY

The present invention provides a nozzle assembly that reliably monitors the dispensed adhesive bead. More particularly, a cooling device for cooling the measuring head with the cameras is arranged adjacent to the measuring head. The measuring head may be designed as an annular member which is positioned concentrically relative to the nozzle and which is arranged at the pipeline block or manifold of the gear pump. The cooling device preferably also has the shape of an annular member which is arranged concentrically relative to the adhesive nozzle. The annular member may surround the nozzle and provide a screen relative to the pipeline block of the gear pump. This means that if the nozzle opens downwardly, the cooling ring may be arranged as an annular disc above the annular measuring head. The nozzle may pass through the measuring head and may project downwardly by a few centimetres, for example. In an advantageous embodiment, the cooling ring comprises one single annular chamber which is supplied with a cooling medium. More particularly, the cooling medium may be cooling air or cooling water supplied via a supply fitting and from which the cooling medium is discharged via a discharge fitting adjoining the supply fitting. Inside the annular chamber, a separating wall may be arranged between the supply fitting and the discharge fitting. However, it is also possible to provide other types of cooling medium conduct means inside the cooling ring.

According to an additional modification, the cooling ring can also enclose an outer face of the measuring head in order to increase the surface area serving to transfer heat for heat discharge purposes. The nozzle commonly comprises heating elements in order to maintain the temperature of the adhesive as far as the nozzle tip at the required level. For reducing the heat transfer from the nozzle to the annular measuring head, it is possible to provide the inside of the nozzle housing with an insulating cover which surrounds the heating elements. Also, to reduce the heat transfer, holding elements for holding the nozzle housing may be fixed to the pipeline block or manifold of the gear pump, and may consist of a composite carbon fiber material with a low thermal conductivity.

To protect the cameras, the measuring head is commonly covered from underneath by a glass plate. Optionally, individual glass plates may be provided for the individual optics. In order to ensure that, at least at this part of the cooled measuring head, the necessarily occurring adhesive vapours are prevented from being deposited, there is proposed an additional device for generating an excess pressure region or an air flow underneath the measuring head to protect the underside of the measuring head from adhesive vapours being deposited. In a simple embodiment, this additional device can comprise exits for at least part of the gaseous cooling medium which can preferably be branched off prior to being supplied to the cooling device. Instead or in addition, the device can comprise a ventilator and suitably arranged nozzle outlets which blow away adhesive vapours from the underside of the measuring head. To the extent that use is made of the terms above and below, this applies to the most frequently used position of the nozzle for applying the adhesive bead from above to a lying substrate. It will be appreciated that a robot arm may turn the adhesive nozzle and all the parts connected thereto in any direction. The supply lines for the hot melt adhesive and the cooling medium as well as the control lines may be designed to be flexible in this case.

An illustrative embodiment of the invention is illustrated in the drawings and will be described below.

### BRIEF DESCRIPTION OF THE DRAWINGS

FIG. 1 shows a nozzle assembly in accordance with the disclosed embodiment in elevational view of the longitudinal axis of the adhesive nozzle.

FIG. 2 shows the nozzle assembly according to FIG. 1 in a longitudinal section through the adhesive nozzle taken along line A-A.

FIG. 3 is a perspective view of the nozzle assembly.

### DETAILED DESCRIPTION

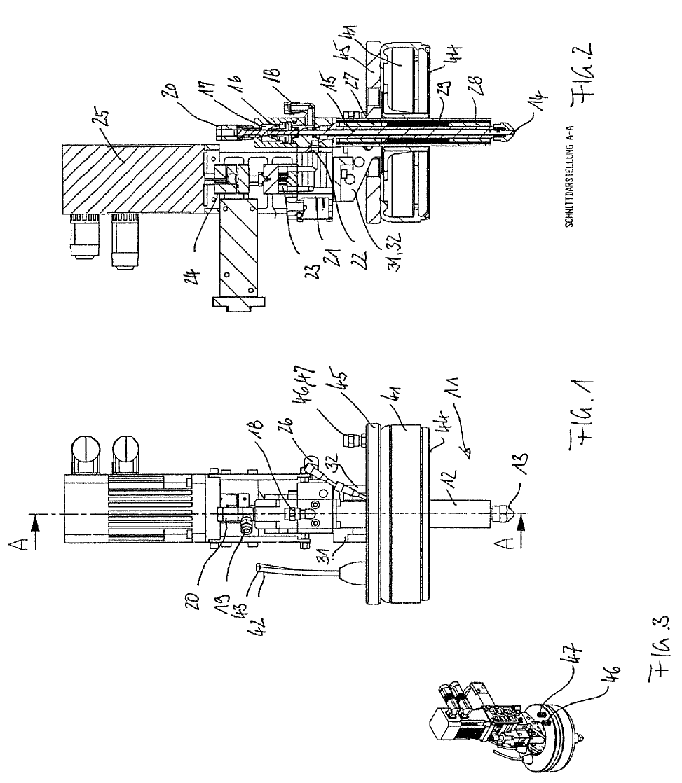

FIGS. 1-3 will be described jointly below. The assembly as illustrated is preferably fixed to a robot arm. The needle nozzle 11 for the hot melt adhesive substantially comprises a nozzle housing 12, a nozzle point or tip 13 with an exit aperture 14 as well as a valve needle 15 which is longitudinally movably arranged inside the nozzle and which is actuated pneumatically. For actuating purposes, a piston 16 which is axially controllable in a pneumatic chamber 17 is fixed to the valve needle 15. At the housing 12, it is possible to identify a first ventilation fitting 1 8 and a second ventilation fitting 1 9. In addition, it is possible to see an air pressure fitting 20. Of course, the various fittings described herein may comprise any other configurations of ports allowing fluid communication to take place. The valve needle 15 is raised or lowered by the piston 16 which is axially displaceable inside the pneumatic chamber 17, so that the exit aperture 14 is opened or closed.

On one side of the nozzle housing 12 there is provided a pipeline block 21 with an adhesive supply fitting which is connected to the nozzle housing 12 via a connecting fitting 22. Pre-heated hot melt adhesive is supplied to the needle nozzle 11 via a gear pump 23 which is connected by a controllable coupling 24 to a motor 25. In the nozzle housing 12 there are arranged two heating elements 27, 28 and an insulating cover 29 which hold the hot melt adhesive supplied on the required processing temperature and, at the same time, largely suppress a heat discharge via the nozzle housing 12.

At the pipeline block 21, a measuring head 41 which is arranged annularly relative to the nozzle is attached to an optical monitoring system via two holding elements 31, 32, with two control and signal lines being connected to the monitoring system. More particularly, the measuring head 41 comprises three circumferentially arranged cameras which are aligned towards the nozzle point 13, which serve to monitor the adhesive bead and which, while the nozzle 11 is in operation, constantly transmit images to an electronic image evaluating system. The cameras are not illustrated in detail. Above the measuring head 41, there is arranged a disc-shaped cooling ring 45 which can be fixed to the measuring head 41 or to the holding elements 31, 32 and is in planar contact with the measuring head 41. The cooling ring 45 comprises two attaching fittings 46, 47 for supplying and discharging a cooling medium; the cooling medium can be provided in the form of air or water. The cooling ring 45 maintains the permissible operating temperature for the cameras in the measuring head 41, which cooling temperature is clearly exceeded by the temperature of the adhesive. To that extent, the invention ensures that the measuring head 41 is insulated relative to the heated hot melt adhesive and cooled by the cooling ring.

The cooling ring 45 can also be designed in such a way that it extends over the outer face of the measuring head 41 in a way which differs from the illustration of the present embodiment, so that in addition to the upper end face of the cylindrical measuring head 41, the outer side surface area, too, is cooled directly. At its lower end, the measuring head 41 is covered with a glass plate 44 to protect the optics of the cameras. To prevent adhesive vapours from being deposited on the glass plate, a gaseous cooling medium can be guided from the cooling ring 45 through the measuring head, emerging centrally, for example, and annularly out of the nozzle housing 12, so that there is generated a radial gas flow along the glass plate from the inside to the outside, which gas flow blows away the adhesive vapour.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept. The scope of the invention itself should only be defined by the appended claims, wherein I claim:

1. A nozzle assembly for dispensing hot melt adhesive at an elevated temperature, comprising:
a nozzle,
a measuring head coupled with said nozzle, said measuring head having a camera for monitoring an adhesive bead produced by the nozzle, and
a cooling device mounted adjacent to the measuring head and operable to maintain said camera at a temperature below the elevated temperature of the hot melt adhesive.

2. The assembly of claim 1, wherein said cooling device further comprises at least one cooling ring arranged concentrically around the nozzle.

3. The assembly of claim 2, wherein said cooling ring further comprises an annular chamber with supply and discharge ports for a cooling medium.

4. The assembly of claim 2, wherein the cooling ring is in a heat-conducting contact with the measuring head via at least one end face.

5. The assembly of claim 1, wherein the nozzle further comprises a needle nozzle.

6. The assembly of claim 1, further comprising:
a housing for the nozzle,
at least one heating element within said housing, and
an insulating cover surrounding said heating element.

7. The assembly of claim 6, wherein said insulating cover comprises melamine foam.

8. The assembly of claim 1, further comprising:
a holding element for the measuring head, said holding element comprising a composite carbon fiber material.

9. The assembly of claim 1, further comprising:
a device for generating a gas flow positioned underneath said measuring head for protecting the underside of the measuring head from hot melt adhesive vapours.

10. The assembly of claim 9, wherein said device includes outlets for directing a gaseous cooling medium used by said cooling device.
